(19) United States
(12) Patent Application Publication
(10) Pub. No.: US 2016/0041099 A1
(43) Pub. Date: Feb. 11, 2016

(54) LIGHT SHEET FLUORESCENCE AND DIFFERENTIAL INTERFERENCE CONTRAST MICROSCOPE

(71) Applicant: University of Oregon, Eugene, OR (US)

(72) Inventors: Raghuveer Parthasarathy, Eugene, OR (US); Ryan Baker, Eugene, OR (US)

(73) Assignee: University of Oregon

(21) Appl. No.: 14/819,359

(22) Filed: Aug. 5, 2015

Related U.S. Application Data
(60) Provisional application No. 62/034,092, filed on Aug. 6, 2014.
(60) Provisional application No. 62/034,109, filed on Aug. 6, 2014.

(51) Int. Cl. G01N 21/64; G02B 21/00

(52) U.S. Cl. CPC G01N 21/6458; G01N 21/6486; G02B 21/0076; G01N 2021/6471; G01N 2021/6478; G01N 2201/0612

(57) ABSTRACT

One or more excitation optical beams are scanned or otherwise directed to a specimen volume to establish a light sheet. Fluorescence from a specimen portion in the light sheet is collected and used to form an image. An interference contrast image of the same or an adjacent specimen portion is obtained by directing an interference contrast optical beam to the specimen so as to be substantially perpendicular to the light sheet. A common imaging device can be used to capture both images, and the resulting image permits correlation of fluorescence image features with specimen structure.

### CROSS REFERENCE TO RELATED APPLICATION

This application claims the benefit of U.S. Provisional Application No. 62/034,092, filed Aug. 6, 2014 and U.S. Provisional Application No. 62/034,109, filed Aug. 6, 2014, both of which are incorporated herein by reference in their entirety.

### ACKNOWLEDGMENT OF GOVERNMENT SUPPORT

This invention was made with government support under DBI MRI, 0922951, awarded by the National Science Foundation, and under 1 P50 GM098911-01A1, awarded by the National Institutes of Health. The government has certain rights in the invention.

### FIELD

The disclosure pertains to light sheet microscopy.

### BACKGROUND

Light sheet fluorescence microscopy (LSFM) enables imaging of a wide variety of specimens. In LSFM, a specimen is illuminated with a light sheet, and an image is formed by detecting light along an axis that is perpendicular to the light sheet. In some applications, LSFM is applied to the imaging of live embryos, multicellular aggregates, and complex biomaterials. LSFM can provide high spatial resolution over large fields of view, with low levels of photo-damage and photo-toxicity. In many applications, LSFM is used to image cells based on fluorescence from fluorescent proteins.

Unfortunately, LSFM does not provide information about non-fluorescent specimen features, and thus correlating LSFM images with specimen structure is difficult. This is particularly disadvantageous for imaging of live specimens. Without information about local specimen structure, the high resolution and large field of view available from LS FM may not be sufficient for developing a detailed understanding of a specimen. Accordingly, improved imaging approaches are needed.

### SUMMARY

According to some examples, fluorescence microscope systems comprise a scanning system that establishes at least one excitation region in a specimen with a scanned excitation beam so as to produce a secondary beam from at least one excitation region at a wavelength that is typically different from the scanned excitation beam. An interference contrast optical system directs an interference contrast optical beam to at least one excitation region, and an imaging system produces a fluorescence image of at least one excitation region based on the secondary beam produced by the scanned excitation beam and an interference contrast image of at least one excitation region based on the interference contrast optical beam. In some examples, the interference contrast image is associated with a spatial region that is nearby or otherwise associated with the excitation region. In other examples, the interference contrast optical beam is directed by the interference contrast optical system along a first axis, wherein the scanning system establishes the excitation region as a light sheet that is perpendicular to the first axis. In some other embodiments, the interference contrast optical beam is directed by the interference contrast optical system along a first axis and the scanning system establishes the excitation region by scanning the excitation beam in a plane perpendicular to the first axis. In still other embodiments, the secondary beam is associated with fluorescence or two photon emission in response to the scanned excitation beam. According to additional embodiments, the scanning system further scans the excitation region, and the imaging system produces an image of a corresponding specimen volume based on the secondary beam and an interference contrast image of the specimen volume.

In some examples, the interference contrast optical system includes a light source and at least one spatial light modulator or birefringent prism that produce a phase difference between portions of the interference contrast optical beam. In yet other examples, the scanning system includes a light source that produces excitation beams at associated excitation wavelengths. A tunable filter receives the excitation beams and delivers a selected excitation beam to the specimen so as to form the excitation region. In other alternatives, a processor determines the selected excitation beam from a plurality of excitation beam wavelengths and controls exposure of the specimen to the excitation beam and the interference contrast optical beam so that images associated with the secondary beam and the interference contrast optical beam are acquired alternately.

Methods comprise exposing a specimen to an excitation beam along a first axis so as to illuminate a sheet of the specimen and produce a secondary beam from the specimen, wherein the secondary beam is at a different wavelength than the excitation beam. Based on the secondary beam, an image of the illuminated sheet of the specimen is produced. A differential interference contrast (DIC) image of the illuminated sheet is also produced, and combined with the secondary beam image. In some examples, the DIC image is obtained by directing an interference contrast optical beam to the illuminated sheet along a second axis that is perpendicular to the first axis. In typical examples, the secondary beam is associated with fluorescence stimulated by the excitation beam. In some alternatives, respective pluralities of secondary beam images and DIC images are obtained from a corresponding plurality of illuminated regions. These secondary beam images and DIC images are combined so as to produce a three dimensional data set. In further embodiments, each of the plurality of secondary beam images is obtained alternately with a corresponding DIC image or each of the plurality of secondary beam images is obtained in a common exposure with a corresponding DIC image.

In some examples, microscopes comprise a condenser lens that directs a first optical beam to a specimen along a first axis. A scanner directs a second optical beam to the specimen so as to define a scanned specimen region, wherein the second optical beam is selected to produce a fluorescence beam in response to the second optical beam. At least one objective lens produces an image of the scanned specimen region based on the first optical beam and the fluorescence beam. A detector receives the image of the scanned specimen region based on the first optical beam and the fluorescence beam. In some examples, the image based on the first optical beam is an interference contrast image, and the second optical beam is scanned so as to define a light sheet that is perpendicular to the first axis. In additional embodiments, an acousto-optic tunable filter selects a wavelength component of an excitation beam and delivers the selected wavelength component to the scanning system as the secondary beam. In further examples, the scanner scans the defined scanned specimen region so as to scan a specimen volume, and a processor receives images associated with the defined scanned specimen region based on the first optical beam and the fluorescence beam so as to produce a three dimensional image.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1 illustrates a representative combined light sheet fluorescence (LSF)/differential interference contrast (DIC) microscope.

FIG. 2 illustrates a representative specimen volume having a light sheet illuminated region.

FIG. 3 is an elevational view illustrating light sheet regions of differing thickness distributed along a selected axis.

FIG. 4 illustrates a combined light sheet fluorescence/differential interference contrast microscope configured to produce a three dimensional image of a specimen.

FIG. 5 illustrates a representative combined light sheet fluorescence/differential interference contrast microscope that includes a spatial light modulator.

FIG. 6 illustrates an imaging method based on differential interference contrast and light sheet fluorescence.

FIG. 7 illustrates LSFM using light sheets formed by illuminating a specimen from different directions.

### DETAILED DESCRIPTION

As used in this application and in the claims, the singular forms “a,” “an,” and “the” include the plural forms unless the context clearly dictates otherwise. Additionally, the term “includes” means “comprises.”

The described systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods which function in the manner described by such theories of operation.

For convenience in the following description, the terms “light” and “optical radiation” refer to propagating electromagnetic radiation in a wavelength range of 100 nm to 10 μm, but other wavelengths can be used. Such radiation can be directed to one or more targets to be profiled, detected, or otherwise investigated. This radiation is referred to herein as propagating in one or more “beams” that typically are based on optical radiation produced by a laser or light emitting diode. As used in this application, beams need not be collimated. For convenience, optical radiation is typically referred to as illumination herein, whether or not such radiation is in a visible range.

For convenience, beams are described as propagating along one or more axes. Such axes generally are based on one or more line segments so that an axis can include a number of non-collinear segments as the axis is bent or folded or otherwise responsive to mirrors, prisms, lenses, and other optical elements. The term “lens” is used herein to refer to a single refractive optical element (a singlet) or a compound lens that includes one or more singlets, doublets, or other compound lenses. In some examples, beams are shaped or directed by refractive optical elements, but in other examples, reflective optical elements such as minors are used, or combinations of refractive and reflective elements are used. Such optical systems can be referred to as dioptric, catoptric, and catadioptric, respectively. Other types of refractive, reflective, diffractive, holographic and other optical elements can be used as may be convenient.

As used herein, “image” refers to a viewable image formed by visible electromagnetic radiation or similar optical images formed by electromagnetic radiation in other wavelength ranges (whether or not visible to the unaided human eye), including both real and virtual images, a corresponding electrical signal provided by an image sensor such as a CMOS sensor array, or image data stored in a memory, whether as voxel or pixel values, or in a form such as a JPEG data file. In some examples, two dimensional images of a specimen section are obtained. In other examples, a series of such images is acquired and used to form a three dimensional image.

The apparatus, systems, and methods disclosed herein can be applied to imaging of a variety of biological and non-biological systems. Some biological specimens of interest include neurons, nematodes, cell cultures, fruit flies, and zebrafish. Representative non-biological systems include emulsions, gels, and lipid vesicles.

Light sheet imaging is described below with reference to fluorescence emission in response to one or more suitable stimulus or excitation beams that produce correspond fluorescence beams or secondary beams. In other examples, 2-photon emission is used for optical sectioning, generally based on pulsed laser beams to provide suitably high optical intensities. As used herein, a light “sheet” is an illuminated region (typically within a specimen) that corresponds to scanning of an optical beam in a plane. Such “sheets” can be associated with specimen sections having opposing planar surfaces, wherein a separation of the surfaces along an axis perpendicular to the surfaces is smaller, typically much smaller, than a spatial extent of the planar surfaces within the specimen. Such illuminated sheets are convenient in many implementations, but other sizes and shapes of illuminated regions can be used as noted below.

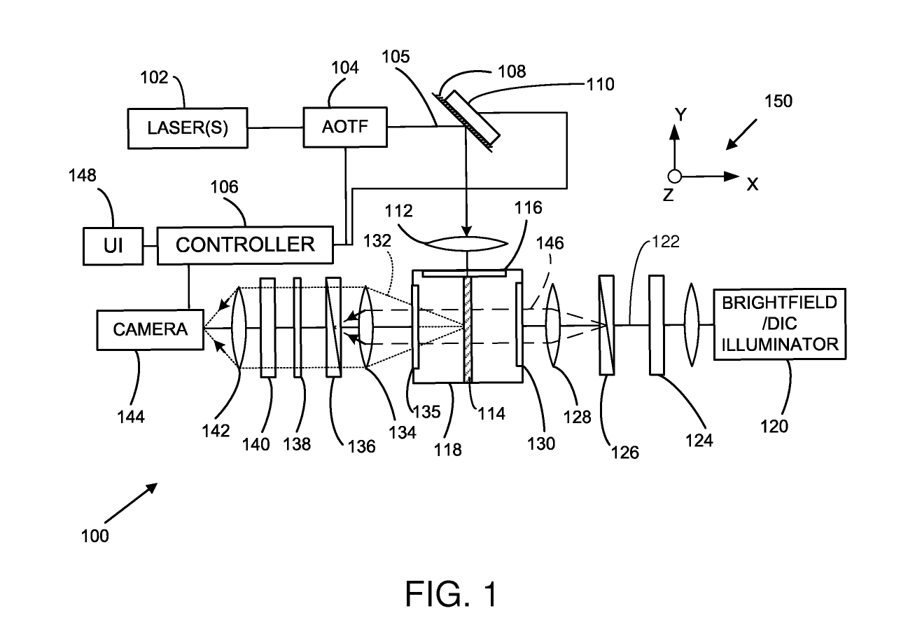

With reference to FIG. 1, a representative LSFM/DIC microscope 100 includes one or more light sources 102 selected to stimulate fluorescence in a specimen. Typically, one or more laser light sources are provided, and can be configured to operate as pulsed or continuous wave lasers. Laser illumination is convenient as such illumination can be more readily shaped and controlled to form sheet or other structured illumination. Illumination from the light sources 102 is directed along an axis 105 to an acousto-optic tunable filter (AOTF) 104 that is coupled to a controller/processor 106. The AOTF 104 is controlled so as to select one or more illumination wavelengths provided by the light sources 102 so that fluorescence can be selectively stimulated by a desired wavelength. In other examples, one or more of the light sources 102 is activated or disabled so as to select suitable stimulus illumination wavelengths. In some cases, illumination beams from the light sources 102 are spatially displaced, and shutters or other beam blocking or diverting devices are used to select the preferred stimulus wavelength(s). While an AOFT permits rapid electronic control of stimulus wavelength, filters or filter wheels can also be used. A user interface 148 is in communication with the controller/processor 106 to permit user selection of scan rates, scan volumes, scan wavelengths, image acquisition parameters, or other values.

A selected stimulus beam is directed to a scan mirror 108 that is coupled to a scan assembly 110 such as a piezoelectric or other scanner. The scan assembly 110 is coupled to the controller 106 that provides suitable drive signals to the scan assembly 110 so as to define an illumination region such as a light sheet in a sample. The scanned stimulus beam is then directed to a lens 112 such as, for example, an f-theta lens, so that the scanned stimulus beam defines an illuminated region 114. In other alternatives, the scan mirror 108 and the scan lens 113 can be replaced with a cylindrical lens. With reference to an XYZ coordinate system 150, the illuminated region 114 generally is a sheet-shaped region that extends in a YZ plane. The illuminated region 114 need not be planar, but can have arbitrary shapes such as one or more distinct linear regions, or an array or series of equally or unequally spaced linear regions associated with the same or different wavelengths. For arbitrary illumination regions, different stimulus wavelengths can be associated with different portions of the illumination regions. The stimulus beam is typically directed through a window 116 in a sample holder 118.

A brightfield illuminator 120 directs an illumination beam along an axis 122 to a polarizer 124 and a Wollaston prism 126. The resulting interference contrast beam (used for differential interference contrast (DIC) imaging) is focused into a specimen region with a lens 128 through a window 130. The brightfield illuminator 120 can include one or more coherent, incoherent, or partially coherent sources such as lasers, lamps, light emitting diodes (LEDs), or other sources. For sufficiently coherent sources such as LEDs, the Wollaston prism 126 can be omitted, and a DIC image still obtained. For polarized illumination sources, the polarizer 124 can be omitted, and a DIC image still obtained. In some examples, a Wollaston prism is not used and a Nomarski prism, Nicol prism, Sénarmont prism, or Rochon prism is used instead.

As shown in FIG. 1, a fluorescence beam 132 is produced in the illumination region 114 and directed by an objective lens 134 through a window 135, a Wollaston prism 136, a filter 138, a polarizer 140 and a tube lens 142 so as to form a fluorescence image at a camera 144. The filter 138 is typically selected to rejected illumination at the stimulus wavelength(s) so that any fluorescence can be detected in the absence of the potentially much large stimulus beam. A DIC image is formed at the camera 144 with a DIC beam 146. In other examples, the lens 134 can be situated on either side of the window 135, or included as part of the window 135.

DIC images and fluorescence images can be alternately acquired by alternating stimulus and DIC illumination. In this way, a single black and white image sensor can be used. In other examples, a color image sensor can be used and stimulus and DIC images acquired and distinguished based on color. Depending on a scan rate provided by the scan assembly, fluorescence and DIC images can be acquired in portions. For example, a single region can be illuminated by the stimulus beam, and a corresponding image of this region acquired. After acquisition of a DIC image of the selected region, a different region can be illuminated and imaged. In some examples, a fluorescence image is acquired line by line between DIC image acquisitions, but other arrangements can be used. If desired, the polarizer 140 and/or the Wollaston prism 136 can be removed from the optical path for fluorescence measurements so as to increase fluorescence collection efficiency.

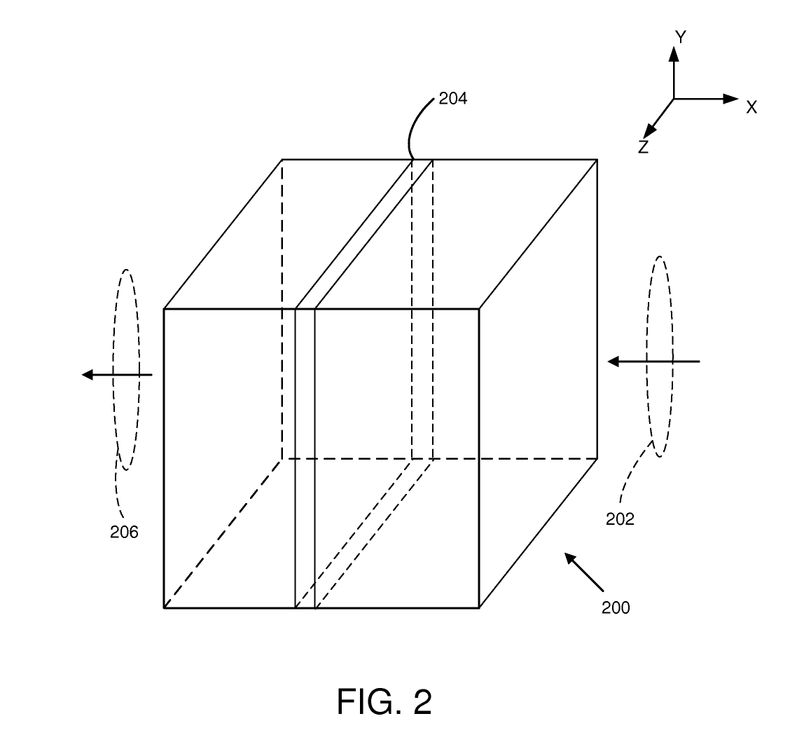

FIG. 2 illustrates a representative sample volume 200. As shown in FIG. 2, a DIC beam 202 is incident along an X-axis, and a sheet 204 that is illuminated by a stimulus beam extends parallel to a YZ-plane. Both DIC illumination and fluorescence exit the sample volume 200 in a combined beam 206. Stimulus beams are scanned to form the sheet 204, and can be scanned so as to translate the sheet 204 along the X-axis. While scanning in the YZ plane and then stepping or scanning along the X-axis may be convenient, scanning in three dimensions can be done in any suitable order.

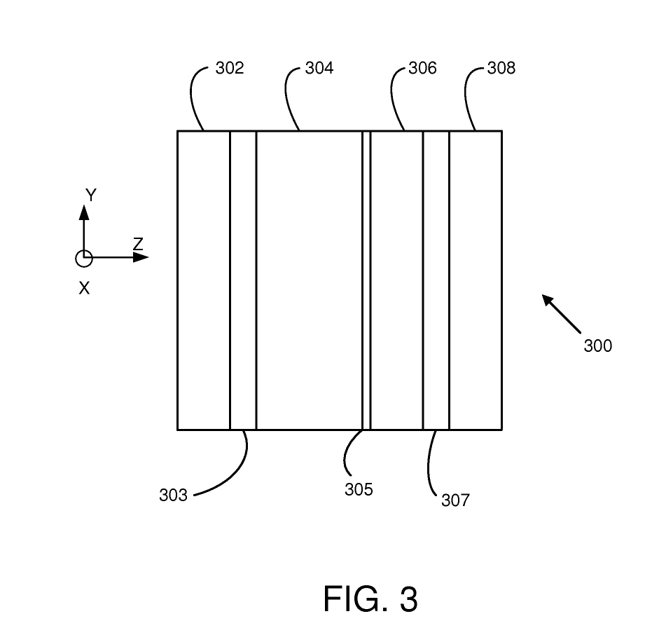

FIG. 3 is an elevational view of sheet illumination based on regions 302-308. Each of these regions can be of a different size and can be associated with a different wavelength. These regions can be scanned during a single fluorescence image acquisition or in series of image acquisitions, with or without interleaved DIC image acquisition. A control system can assemble partial images as desired to form a complete two or three dimensional image.

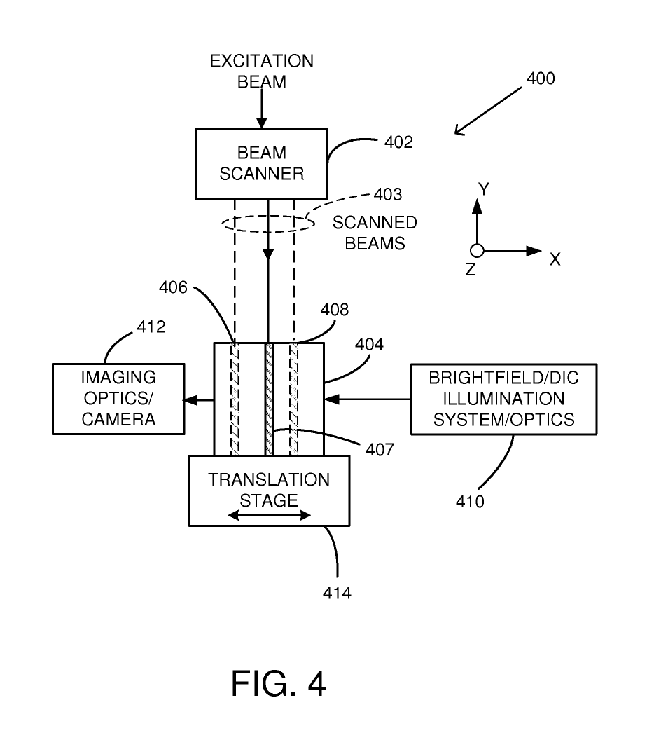

A three-dimensional imaging system 400 is illustrated in FIG. 4. An excitation beam is directed by a beam scanner 402 to a specimen volume 404. As shown in FIG. 4, the excitation beam is scanned so as to produce excitation sheets 406, 407, 408 that are displaced in an X-direction and formed by beam scanning in the YZ-plane. Typically, the beam scanner 402 produces a series of excitation sheets that scan the entire specimen volume 404. Brightfield/DIC optics 410 direct a DIC beam through the sample volume 404, and imaging optics and a camera or other detector 412 capture DIC and fluorescence images so as to provide three dimensional image data that can be stored and/or delivered to a suitable image processor. In some examples, a translation stage 414 moves the specimen volume 404 so that a spatially fixed excitation sheet is scanned through the specimen volume 404. The scanned beams can be modulated if desired.

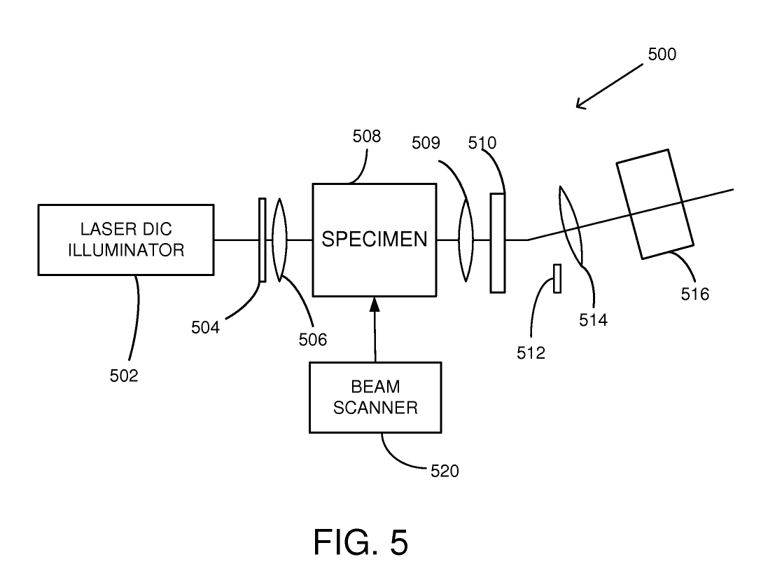

Referring to FIG. 5, an imaging system 500 includes a laser illuminator for DIC that directs a beam to a rotatable diffuser 504 situated at a focal plane of a condenser lens 506. In other examples, an LED is used for illumination. In the configuration of FIG. 5, relatively high optical beam coherence is preferred, and can be obtained from a laser or an LED. The diffused beam is directed to a specimen volume 508 and a transmitted beam is captured by an objective lens 509. A spatial light modulator (SLM) 510 applies a predetermined spatially varying pattern to the beam. A portion of the patterned beam is directed to an imaging lens 514 while other portions are blocked by a stop 512. The imaging lens 514 produces a specimen image based on DIC at an image sensor 516. A beam scanner 520 provides an excitation beam to the specimen volume 508, typically as a light sheet, and a secondary beam (based on fluorescence or a two-photon interaction) is processed so as to form an associated image that is captured by the image sensor 516. A controller/processor (not shown in FIG. 5) is in communication with the beam scanner 520, the illuminator 502, the SLM 510, and the camera 516 to establish scan parameters, scan wavelengths, excitation beam wavelength(s), and control storage and communication of acquired image data.

The SLM 510 can be a liquid crystal SLM that includes a vertically aligned nematic, a parallel aligned nematic, or a twisted nematic liquid crystal situated between polarizers. The SLM 510 can be used to define parallel or non-parallel dual gratings having a predetermined frequency difference and phase difference to produce interference between beams, and thereby permit differential interference contrast imaging.

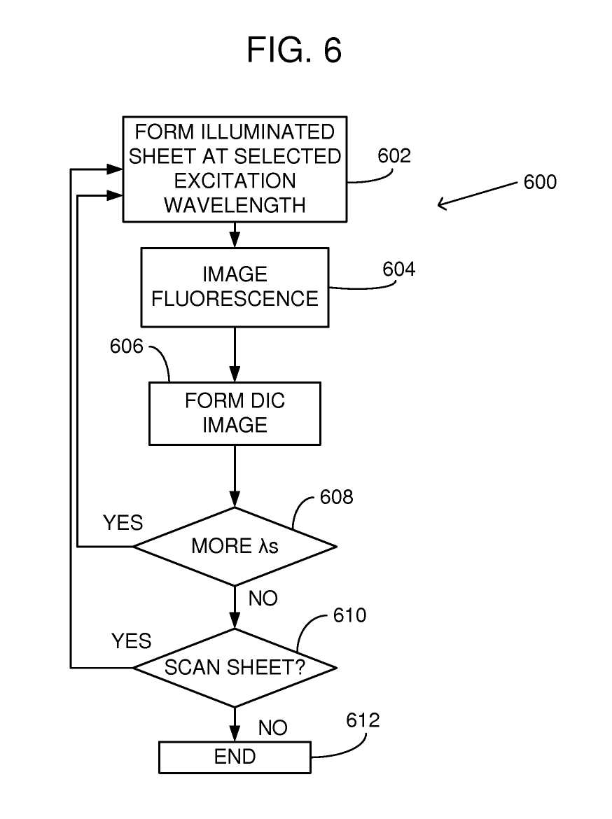

A method 600 of combined DIC and fluorescence imaging is illustrated in FIG. 6. At 602, an illuminated sheet region is formed in a specimen at a selected excitation wavelength, and at 604 an associated fluorescence image is acquired. At 606 a DIC image of the illuminated sheet region is obtained. At 608, it is determined if additional excitation wavelengths are to be used. If so, an additional illuminated sheet at a newly selected wavelength is formed at 602. Otherwise, at 610, it is determined if additional sheet locations are desired. If so, an additional illuminated sheet at a newly selected location is formed at 602. With all excitation wavelengths and sheet locations used, image acquisition ends at 612. DIC and fluorescence imaging can be alternated or done simultaneously, and a particular order such as shown in FIG. 6 is not required. Illuminated regions (sheets) for different excitation wavelengths can have different shapes, sizes, or orientations, or can be substantially the same.

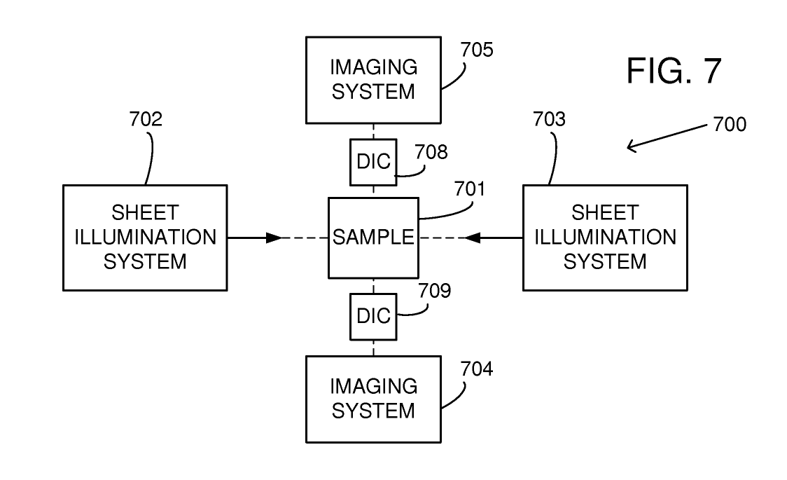

As shown in FIG. 7, light sheet images can be obtained from different directions of incidence. In the apparatus 700, light sheet illumination systems 702, 703 direct light sheets to a sample 701 from opposing (or other different directions). Imaging systems 704, 705 are situated to capture and form images based on lights sheets formed by either of the light sheet illumination systems 702, 703. DIC optical systems 708, 709 can be inserted as desired so that DIC and LSFM images can be combined.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A microscope system, comprising:
an excitation beam optical system that establishes at least one excitation region in a specimen so as to produce a secondary beam at a wavelength different from the excitation beam;
an interference contrast optical system that directs an interference contrast optical beam to the at least one excitation region; and
an imaging system that produces an image of the at least one excitation region based on the secondary beam produced by the excitation beam and an interference contrast image of the at least one excitation region based on the interference contrast optical beam.

2. The microscope system of claim 1, wherein the excitation beam optical system includes a scanning system that establishes the at least one excitation region in the specimen with a scanned excitation beam.

3. The microscope system of claim 2, wherein the interference contrast optical beam is directed by the interference contrast optical system along a first axis, wherein the scanning system establishes the excitation region as a sheet that is perpendicular to the first axis.

4. The microscope system of claim 2, wherein the interference contrast optical beam is directed by the interference contrast optical system along a first axis and the scanning system establishes the excitation region by scanning the excitation beam in a plane perpendicular to the first axis.

5. The microscope system of claim 2, wherein the interference contrast optical beam is directed by the interference contrast optical system along a first axis and the scanning system establishes the excitation region by scanning the specimen in a plane perpendicular to the first axis.

6. The microscope system of claim 2, wherein the secondary beam is associated with fluorescence in response to the scanned excitation beam.

7. The microscope system of claim 2, wherein the secondary beam is associated with two photon emission in response to the scanned excitation beam.

8. The microscope system of claim 2, wherein the scanning system further scans the excitation region, and the imaging system produces an image of a corresponding specimen volume based on the secondary beam and an interference contrast image of the specimen volume.

9. The microscope of claim 8, wherein the interference contrast optical system includes a light source and at least one spatial light modulator or birefringent prism that produce a phase difference between portions of the interference contrast optical beam.

10. The microscope of claim 2, wherein the scanning system includes:
a light source that produces excitation beams at associated excitation wavelengths; and
a tunable filter that receives the excitation beams and delivers a selected excitation beam to the specimen so as to form the excitation region.

11. The microscope system of claim 2, further comprising a processor that determines the selected excitation beam from a plurality of excitation beam wavelengths and controls exposure of the specimen to the excitation beam and the interference contrast optical beam so that images associated with the secondary beam and the interference contrast optical beam are acquired alternately.

12. A method, comprising:
exposing a specimen to an excitation beam along a first axis so as to produce a secondary beam from the specimen so as to illuminate a sheet of the specimen, wherein the secondary beam is at a different wavelength than the excitation beam;
based on the secondary beam, producing a secondary beam image of the illuminated sheet of the specimen; and
producing a differential interference contrast (DIC) image of the illuminated sheet.

13. The method of claim 12, wherein the DIC image is obtained by directing an interference contrast optical beam to the illuminated sheet along a second axis that is perpendicular to the first axis.

14. The method of claim 13, wherein the secondary beam is associated with fluorescence stimulated by the excitation beam.

15. The method of claim 13, further comprising:
obtaining a plurality of secondary beam images and DIC images of a corresponding plurality of illuminated regions; and
combining the plurality of secondary beam images and the plurality of DIC images so as to produce a three dimensional data set.

16. The method of claim 15, wherein each of the plurality of secondary beam images is obtained alternately with a corresponding DIC image.

17. The method of claim 15, wherein each of the plurality of secondary beam images is obtained in a common exposure with a corresponding DIC image.

18. A microscope, comprising:
a condenser lens that directs a first optical beam to a specimen along a first axis;
a stimulus beam optical system that directs a second optical beam to the specimen so as to define an excitation region, wherein the second optical beam is selected to produce a fluorescence beam in response to the second optical beam;
at least one objective lens that produces an image of the excitation region based on the first optical beam and the fluorescence beam; and
a detector that receives the image of the excitation region based on the first optical beam and the fluorescence beam.

19. The microscope of claim 18, wherein the stimulus beam optical system includes a cylindrical lens that directs the second optical beam to the specimen so as to define the excitation region as an illuminated sheet.

20. The microscope of claim 18, wherein the stimulus beam optical system includes a scanner that directs the second optical beam to the specimen so as to define the excitation region as a scanned specimen region.

21. The microscope of claim 20, wherein the image based on the first optical beam is an interference contrast image, and the second optical beam is scanned so as to define a sheet that is perpendicular to the first axis.

22. The microscope of claim 21, further comprising an acousto-optic tunable filter that selects a wavelength component of an excitation beam and delivers the selected wavelength component to the scanning system as the secondary beam.

23. The microscope of claim 21, wherein the scanner further scans the defined scanned specimen region so as to scan a specimen volume, and a processor receives images associated with the defined scanned specimen region based on the first optical beam and the fluorescence beam so as to produce a three dimensional image.
